(19) United States
(12) Patent Application Publication
(10) Pub. No.: US 2025/0046914 A1
(43) Pub. Date: Feb. 6, 2025

(54) THERMAL MANAGEMENT CONFIGURATIONS FOR BATTERY PACK

(71) Applicant: Ford Global Technologies, LLC, Dearborn, MI (US)

(72) Inventors: Di Zhu, Novi, MI (US); Steven Shi, NanJing (CN); Charles C. Poon, Canton, MI (US)

(21) Appl. No.: 18/378,173

(22) Filed: Oct. 10, 2023

Related U.S. Application Data
(60) Provisional application No. 63/530,544, filed on Aug. 3, 2023.

(51) Int. Cl. H01M 10/658; H01M 10/625; H01M 10/651; H01M 50/317

(52) U.S. Cl. CPC H01M 10/658; H01M 10/625; H01M 10/651; H01M 50/317; H01M 2220/20

(57) ABSTRACT

A battery assembly for an electrified vehicle may include a battery array having a first battery cell, a second battery cell, and a thermal barrier between the first and second battery cells. A dimension of the thermal barrier is greater than a corresponding dimension of the first and second battery cells.

### TECHNICAL FIELD

This disclosure relates to thermal management configurations for a battery pack, such as a battery pack of an electrified vehicle, and a corresponding method.

### BACKGROUND

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by battery powered electric machines. Conventional motor vehicles, by contrast, rely exclusively on an internal combustion engine to propel the vehicle.

A high voltage battery pack typically powers the electric machines and other electrical loads of the electrified vehicle. The battery pack includes a plurality of battery cells and various other battery internal components that support electric propulsion of electrified vehicles.

### SUMMARY

In some aspects, the techniques described herein relate to a battery assembly for an electrified vehicle, including: a battery array having a first battery cell, a second battery cell, and a thermal barrier between the first and second battery cells, wherein a dimension of the thermal barrier is greater than a corresponding dimension of the first and second battery cells.

In some aspects, the techniques described herein relate to a battery assembly, further including: an array cover, and a layer vertically between a top of the first and second battery cells and the array cover, wherein the layer includes a slot receiving a top section of the thermal barrier.

In some aspects, the techniques described herein relate to a battery assembly, wherein the slot is aligned with a vent of the array cover relative to a length of the battery array.

In some aspects, the techniques described herein relate to a battery assembly, wherein the slot is sized and shaped to receive the top section of the thermal barrier and to permit gases to flow to a vent of the array cover.

In some aspects, the techniques described herein relate to a battery assembly, wherein the layer includes another slot aligned with a vent of the array cover, wherein the other slot is spaced-apart from the slot receiving the top section of the thermal barrier relative to a length of the battery array.

In some aspects, the techniques described herein relate to a battery assembly, wherein a top-most surface of the thermal barrier is arranged vertically above the layer.

In some aspects, the techniques described herein relate to a battery assembly, wherein the top-most surface of the thermal barrier is spaced-apart below a bottom-most surface of the array cover.

In some aspects, the techniques described herein relate to a battery assembly, wherein the top-most surface of the thermal barrier is in contact with a bottom-most surface of the array cover.

In some aspects, the techniques described herein relate to a battery assembly, wherein the thermal barrier includes mica and aerogel.

In some aspects, the techniques described herein relate to a battery assembly, wherein the thermal barrier includes a mica-aerogel-mica sandwich.

In some aspects, the techniques described herein relate to a battery assembly, wherein the thermal barrier includes an aerogel-mica-aerogel sandwich.

In some aspects, the techniques described herein relate to a battery assembly, wherein the thermal barrier includes a non-symmetrical arrangement of layers of material.

In some aspects, the techniques described herein relate to a battery assembly, wherein the thermal barrier includes layers of aerogel, glass fiber, and polyurethane foam.

In some aspects, the techniques described herein relate to a battery assembly, wherein at least a portion of the thermal barrier projects through a slot in an array cover.

In some aspects, the techniques described herein relate to a battery assembly, further including: an array cover; wherein the thermal barrier includes a flap adjacent a top section of the thermal barrier and projecting from the top section of the thermal barrier, and the flap is deflectable from a neutral position to a deflected position in which the flap contacts the array cover.

In some aspects, the techniques described herein relate to a battery assembly, wherein the dimension of the thermal barrier is a height, and the corresponding dimension of the first and second battery cells is a height.

In some aspects, the techniques described herein relate to an electrified vehicle, including: a battery assembly including a battery array having a first battery cell, a second battery cell, and a thermal barrier between the first and second battery cells, wherein a dimension of the thermal barrier is greater than a corresponding dimension of the first and second battery cells.

In some aspects, the techniques described herein relate to an electrified vehicle, further including: an array cover, and a layer vertically between a top of the first and second battery cells and the array cover, wherein the layer includes a slot receiving a top section of the thermal barrier.

In some aspects, the techniques described herein relate to an electrified vehicle, wherein the thermal barrier projects through a slot in an array cover.

In some aspects, the techniques described herein relate to a method, including: sealing a compartment of a battery array of a battery assembly of an electrified vehicle using a thermal barrier arranged between first and second battery cells, wherein a dimension of the thermal barrier is greater than a corresponding dimension of the first and second battery cells.

### BRIEF DESCRIPTION OF THE DRAWINGS

FIG. 1 schematically illustrates a powertrain for an electrified vehicle.

FIG. 2 is a partial view of an exemplary battery array in cross-section.

FIG. 3 is a close-up view of a portion of the exemplary battery array of FIG. 2.

FIG. 4 is a top view of a portion of a layer of the battery array of FIG. 2. The layer includes an alternating arrangement of differently-sized slots.

FIG. 5 is a top view of the layer of FIG. 4, with battery cells and thermal barriers arranged relative to the slots.

FIG. 6 is a cross-sectional view of a portion of an exemplary battery array, and in particular illustrates an embodiment in which the cover includes flaps in contact with the thermal barriers.

FIG. 7 is a cross-sectional view of a portion of an exemplary battery array, and in particular illustrates an embodiment in which the thermal barriers include a deflectable flap.

FIG. 8A is a cross-sectional view of a portion of an exemplary battery array, and in particular illustrates an embodiment in which the layer includes slots configured to receive the thermal barriers and also provide venting functionality.

FIG. 8B is a top view of a portion of the layer of FIG. 8A.

FIG. 9 is a partial view of another exemplary battery array in cross-section.

### DETAILED DESCRIPTION

This disclosure relates to thermal management configurations for a battery pack, such as those used in electrified vehicles, and a corresponding method. The disclosed arrangements seal adjacent compartments, each of which contains one or more battery cells, thereby reducing heat propagation between adjacent compartments and facilitating venting.

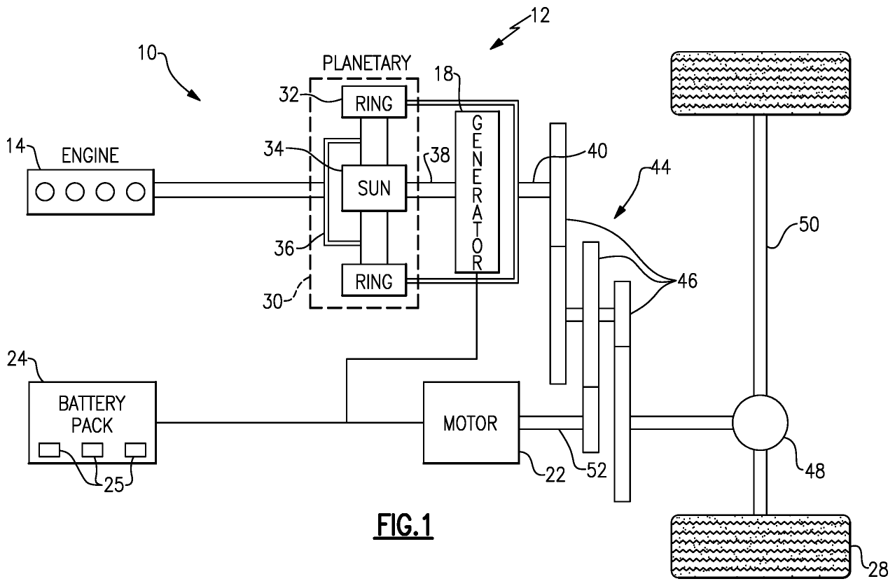

FIG. 1 schematically illustrates a powertrain 10 for an electrified vehicle 12 (“vehicle 12”). Although depicted as a hybrid electric vehicle (HEV), it should be understood that the concepts described herein are not limited to HEVs and could extend to other electrified vehicles, including, but not limited to, plug-in hybrid electric vehicles (PHEVs) and battery electric vehicles (BEVs).

In one embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery assembly 24. In this example, the second drive system is considered an electric drive system of the powertrain 10. The first and second drive systems generate torque to drive one or more sets of vehicle drive wheels 28 of the vehicle 12. Although a power-split configuration is shown, this disclosure extends to any hybrid or electric vehicle including full hybrids, parallel hybrids, series hybrids, mild hybrids or micro hybrids.

The engine 14, which in one embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In one embodiment, the motor 22 and the generator 18 can be employed as motors to output torque. For example, the motor 22 and the generator 18 can each output electrical power to the battery assembly 24.

The battery assembly 24 is an exemplary electrified vehicle battery. The battery assembly 24 may be a high voltage traction battery pack that includes a plurality of battery arrays 25, or other groupings of battery cells, capable of outputting electrical power to operate the motor 22, the generator 18, and/or other electrical loads of the vehicle 12.

The vehicle 12 may additionally operate in a Hybrid (HEV) mode in which the engine 14 and the motor 22 are both used for vehicle propulsion. The HEV mode is an example of a charge sustaining mode of operation for the vehicle 12. During the HEV mode, the vehicle 12 may reduce the motor 22 propulsion usage in order to maintain the state of charge of the battery assembly 24 at a constant or approximately constant level by increasing the engine 14 propulsion usage. The vehicle 12 may be operated in other operating modes in addition to the EV and HEV modes within the scope of this disclosure.

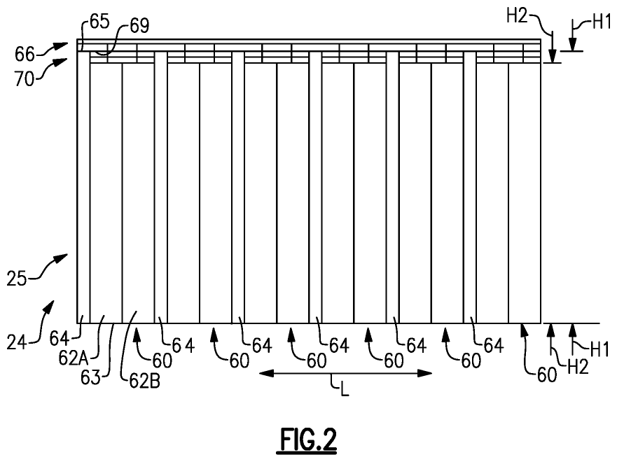

FIG. 2 illustrates additional detail of some components of an example battery assembly 24 in cross-section. The battery assembly 24 includes at least one array 25. The array 25 includes a plurality of compartments 60, each including structures following the same pattern, along the length L of the array 25. For instance, with respect to one of the compartments 60, the compartment 60 includes two cells 62A, 62B in direct contact with one another within the single compartment 60. The compartments 60 are separated by barriers 64, which may be referred to as thermal barriers. The barriers 64 are vertically-extending walls, with reference to FIG. 2, and also extend between sidewalls of the battery assembly 24, generally in-and-out of the page relative to FIG. 2. Each barrier 64 may be made of a mica-aerogel-mica sandwich, with the layers of the sandwich being sandwiched relative to the length L (i.e., in the left-to-right direction in FIG. 2). In this embodiment, layers of mica protect the layer of aerogel, which slows conduction of heat. In a further embodiment, the barrier 64 includes a 0.5 mm thick layer of mica, a 3.5 mm thick layer of aerogel, and a 0.5 mm thick layer of mica.

Alternatively, the barriers 64 could be provided by a sandwich of aerogel-mica-aerogel. Further still, the barriers 64 could be provided by a sandwich of aerogel-glass fiber-aerogel. Instead of aerogel, other materials such as alkaline earth silicate (AES) insulations may be used. The barriers 64 may also include a non-symmetric arrangement of layers of material in the left-to-right direction in some embodiments. For instance, the barriers 64 could be provided by an arrangement including a layer of aerogel-glass fiber-polyurethane foam, moving from left-to-right in FIG. 2, for example.

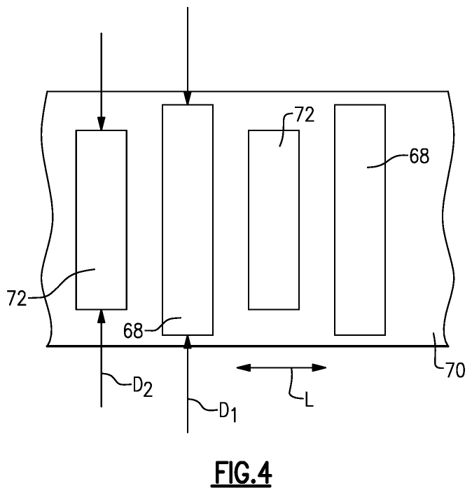

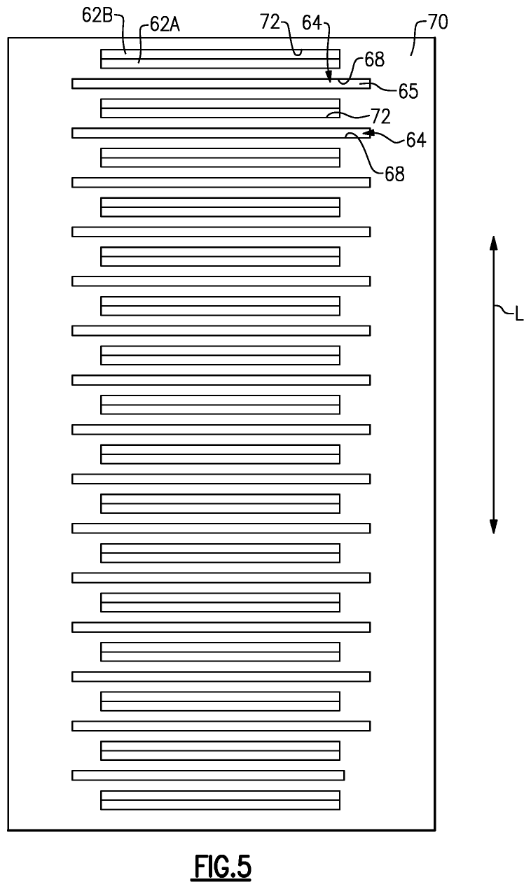

The barriers 64 exhibit a height H₁ greater than a height H₂ of the cells 62A, 62B, which serves to direct vent gases away from adjacent compartments 60, and instead direct those vent gases generally in the vertically upward direction (relative to FIG. 2). The heights H₁, H₂ are measured from a bottom surface 63, which may be a bottom of a tray, of the battery assembly 24, upon which the cells 62A, 62B and barriers 64 are directly supported. In this embodiment, a top section, which includes a top-most surface 65, of each barrier 64 is arranged adjacent an array cover 66, which here is a top cover and is arranged generally opposite the bottom surface 63. More particularly, the top-most surface 65 of each barrier 64 projects into and through slots 68 in a layer 70. The layer 70 is vertically beneath the array cover 66, as generally shown in FIGS. 2-5. The layer 70 may include sheets of mica and polyurethane foam, in one embodiment.

With joint reference to FIGS. 2-5, the top-most surfaces 65 may contact the bottom 69 of the array cover 66 directly. The layer 70 includes an alternating arrangement of slots, including slots 72 aligned with vents in the array cover 66, and the slots 68 for receiving barriers 64, in this embodiment. The slots 68 exhibit at least one different dimension than the slots 72. In this example, slots 68 exhibit a greater dimension D₁ than a dimension D₂ of the slots 72. Dimensions D₁, D₂ are length dimensions of the slots 68, 72, and are measured relative to the width of the battery assembly 24, in this example.

In the example, the slots 68 are sized and shaped such that the layer 70 directly contacts the barriers 64. The contact between the barriers 64 and the layer 70 seals each compartment 60. Contact between the layer 70 and the array cover 66, and/or the barriers 64 and the array cover 66, further seals each compartment 60.

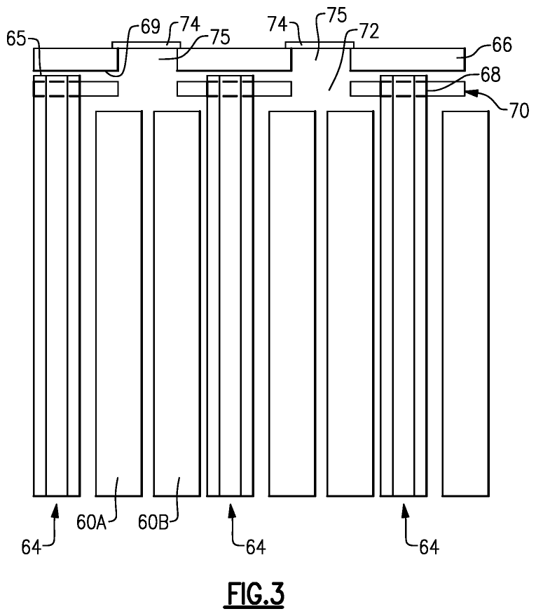

The array cover 66 includes vent flaps 74 (FIG. 3), in this example, which are configured to selectively flap open when subjected to relatively high pressure from within a corresponding one of the compartments 60. The vent flaps 74 cover a corresponding vent opening 75 of the array cover 66, in this example. The vent flaps 74 could cover two or more vent openings 75 of the array cover 66 in other embodiments. The vent flaps 74 could be provided be attached to the array cover 66, or formed by scoring the array cover 66, such as by scoring three edges of a rectangular shape of the array cover 66. The vent flaps 74 may be covered by a layer of mica or another material.

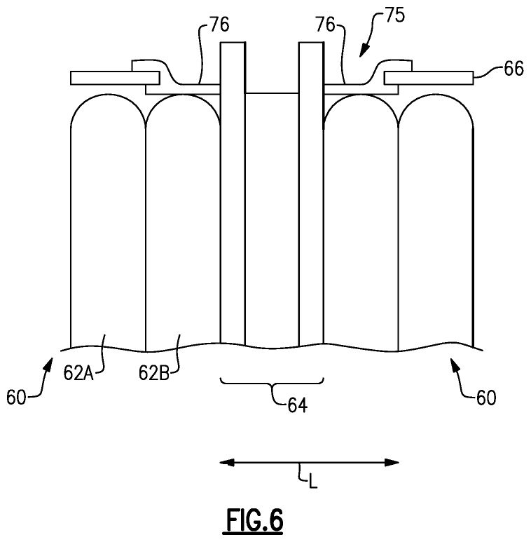

In the embodiment of FIG. 6, the barrier 64 project into, and through, the vent openings 75 in the array cover 66. A flap 76, which may be made of mica, projects into contact with the barrier 64. The flap 76 may be attached to the array cover 66 with tape or another type of adhesive. In FIG. 6, two flaps 76 project into each vent opening 75 in the array cover 66. Further, in FIG. 6, the outer layers of the sandwich forming the barrier 64 project above the array cover 66. While not shown, the layer 70 could be present in the embodiment of FIG. 6. Alternatively, the layer 70 is not required.

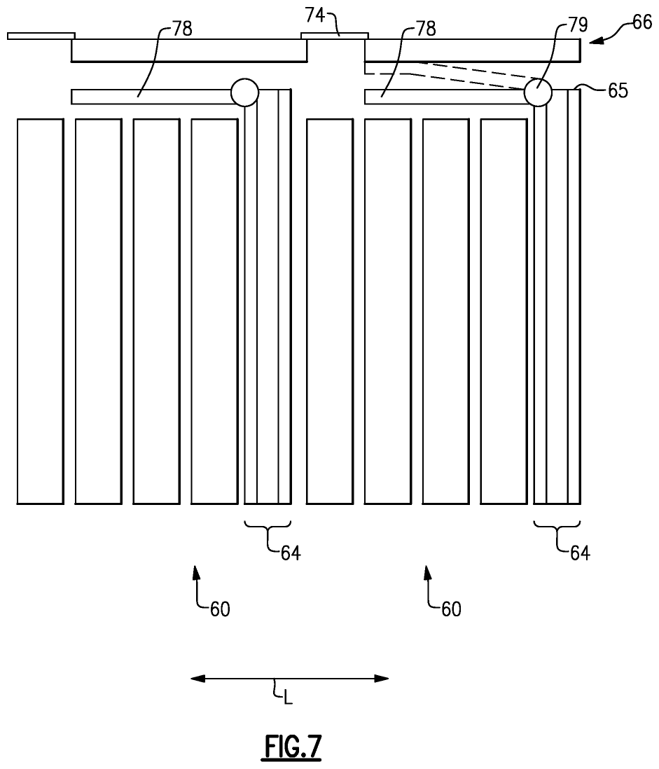

As shown in FIG. 7, a hinged flap 78 projects from the barriers 64 and is provided adjacent the array cover 66 to establish a seal between adjacent compartments 60 in the event of a release of vent gases. A hinge point 79 of the hinged flap 78 is adjacent the top-most surface 65 of the barrier 64, in this example. In FIG. 7, the flaps 78 are shown in a waiting, or neutral position. The flaps 78 are moveable to a deflected position. A deflected position is represented in dashed-lines relative to the right-hand flap 78. In the deflected position, vent gases deflect the flap 78 such that the flap 78 contacts the array cover 66 to establish a seal between adjacent compartments 60 and to direct gas flow to through the vent flaps 74. While not shown, the layer 70 could be present in the embodiment of FIG. 7. Alternatively, the layer 70 is not required.

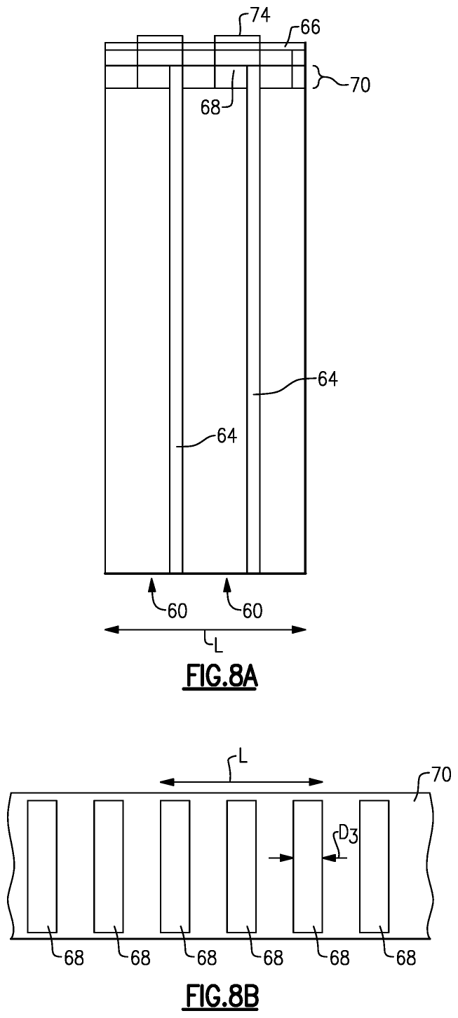

As shown in FIGS. 8A and 8B, the slots 68 of the layer 70 are sized and shaped so as to receive a barrier 64 and to permit fluid to flow to the vents flaps 74 (one example vent flap 74 is shown) of the array cover 66. With reference to FIG. 8B, each of the slots 68 exhibits a dimension D₃ greater than a thickness of the barriers 64. The dimension D₃ is a width of the slots 68 and is measured parallel to the length L. The slots 68 are aligned relative to the length L of the array 25 with the vents flaps 74. In FIGS. 8A and 8B, there is one battery cell per compartment.

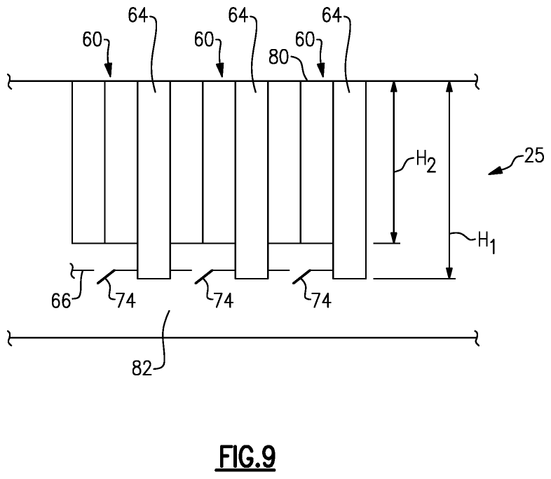

While in the above-discussed embodiments, the cells 62A, 62B are supported relative to their respective bottom surfaces, the cells 62A, 62B could be supported from another surface, such as a top surface or side surface, in other embodiments. As an example, in FIG. 9, the cells 62A, 62B are supported relative to a top barrier 80 of the array 25. In this configuration, each compartment 60 includes two cells 62A, 62B separated by barriers 64. As in the previous embodiments, the barriers 64 exhibit a greater height dimension H₁ than a height dimension H₂ of the cells 62A, 62B. The barriers 64 project vertically downward relative to the top barrier 80 through corresponding slots in the cover 66, which is a bottom cover 66 in this example. Vent flaps 74 are configured to direct gases through a channel 72. In examples where the cells 62A, 62B are supported relative to their side, the dimension of the cells in the side-to-side direction may be less than a corresponding side-to-side dimension of the barriers 64.

It should be understood that terms such as “about,” “substantially,” and “generally” are not intended to be boundaryless terms, and should be interpreted consistent with the way one skilled in the art would interpret those terms. It should also be understood that directional terms such as “upper,” “top,” “vertical,” “forward,” “rear,” “side,” “above,” “below,” etc., are used herein relative to the normal operational attitude of a vehicle for purposes of explanation only, and should not be deemed limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery assembly for an electrified vehicle, comprising:
a battery array having a first battery cell, a second battery cell, and a thermal barrier between the first and second battery cells, wherein a dimension of the thermal barrier is greater than a corresponding dimension of the first and second battery cells.

2. The battery assembly as recited in claim 1, further comprising:
an array cover, and
a layer vertically between a top of the first and second battery cells and the array cover, wherein the layer includes a slot receiving a top section of the thermal barrier.

3. The battery assembly as recited in claim 2, wherein the slot is aligned with a vent of the array cover relative to a length of the battery array.

4. The battery assembly as recited in claim 3, wherein the slot is sized and shaped to receive the top section of the thermal barrier and to permit gases to flow to a vent of the array cover.

5. The battery assembly as recited in claim 2, wherein the layer includes another slot aligned with a vent of the array cover, wherein the other slot is spaced-apart from the slot receiving the top section of the thermal barrier relative to a length of the battery array.

6. The battery assembly as recited in claim 2, wherein a top-most surface of the thermal barrier is arranged vertically above the layer.

7. The battery assembly as recited in claim 6, wherein the top-most surface of the thermal barrier is spaced-apart below a bottom-most surface of the array cover.

8. The battery assembly as recited in claim 6, wherein the top-most surface of the thermal barrier is in contact with a bottom-most surface of the array cover.

9. The battery assembly as recited in claim 1, wherein the thermal barrier includes mica and aerogel.

10. The battery assembly as recited in claim 9, wherein the thermal barrier includes a mica-aerogel-mica sandwich.

11. The battery assembly as recited in claim 9, wherein the thermal barrier includes an aerogel-mica-aerogel sandwich.

12. The battery assembly as recited in claim 1, wherein the thermal barrier includes a non-symmetrical arrangement of layers of material.

13. The battery assembly as recited in claim 12, wherein the thermal barrier includes layers of aerogel, glass fiber, and polyurethane foam.

14. The battery assembly as recited in claim 1, wherein at least a portion of the thermal barrier projects through a slot in an array cover.

15. The battery assembly as recited in claim 1, further comprising:
an array cover;
wherein the thermal barrier includes a flap adjacent a top section of the thermal barrier and projecting from the top section of the thermal barrier, and the flap is deflectable from a neutral position to a deflected position in which the flap contacts the array cover.

16. The battery assembly as recited in claim 1, wherein the dimension of the thermal barrier is a height, and the corresponding dimension of the first and second battery cells is a height.

17. An electrified vehicle, comprising:
a battery assembly including a battery array having a first battery cell, a second battery cell, and a thermal barrier between the first and second battery cells, wherein a dimension of the thermal barrier is greater than a corresponding dimension of the first and second battery cells.

18. The electrified vehicle as recited in claim 17, further comprising:
an array cover, and
a layer vertically between a top of the first and second battery cells and the array cover, wherein the layer includes a slot receiving a top section of the thermal barrier.

19. The electrified vehicle as recited in claim 17, wherein the thermal barrier projects through a slot in an array cover.

20. A method, comprising:
sealing a compartment of a battery array of a battery assembly of an electrified vehicle using a thermal barrier arranged between first and second battery cells, wherein a dimension of the thermal barrier is greater than a corresponding dimension of the first and second battery cells.
